(19) United States
(12) Patent Application Publication
(10) Pub. No.: US 2025/0274337 A1
(43) Pub. Date: Aug. 28, 2025

(54) NETWORK OPTIMIZATION AND REPAIR USING ARTIFICIAL INTELLIGENCE (AI) / MACHINE LEARNING (ML)

(71) Applicant: DISH Wireless L.L.C., Englewood, CO (US)

(72) Inventors: Dilip TANDEKAR, Herndon, VA (US); Gurpreet SOHI, Parker, CO (US); Sourabh GUPTA, Ashburn, VA (US)

(73) Assignee: DISH Wireless L.L.C., Englewood, CO (US)

(21) Appl. No.: 18/587,486

(22) Filed: Feb. 26, 2024

(51) Int. Cl. H04L 41/0654; H04L 41/16

(52) U.S. Cl. CPC H04L 41/0654; H04L 41/16

(57) ABSTRACT

Network optimization and repair using Artificial Intelligence (AI)/Machine Learning (ML) is disclosed. More specifically, AI/ML models are trained to predict hardware and software failures of Radio Access Network (RAN) components by analyzing telemetry data and/or trained to extend battery life during power failures. The telemetry data may include performance logs from performance monitors, fault logs from fault monitors, and traffic information for traffic flowing through the RAN. Hardware specifications of the RAN equipment, operating temperatures, power consumption, etc. may also be stored and monitored. This data may be monitored across the infrastructure, platform, and application layers. One or more rApps in a Non-Real Time RAN Intelligent Controller (NRT RIC) may use the AI/ML models to predict failures, and potentially, provide an indication of an estimated time when failure is predicted to occur.

### FIELD

The present invention generally relates to communications, and more specifically, to network optimization and repair using Artificial Intelligence (AI)/Machine Learning (ML).

### BACKGROUND

Various issues may occur in the computing systems of Radio Access Networks (RANs). For instance, memory leaks may occur, hardware may fail, power supplies may be cut off due to a natural disaster or an accident, etc. In current RAN implementations, these issues may degrade radio network performance, or the radio network may even fail entirely. Accordingly, an improved and/or alternative approach may be beneficial.

### SUMMARY

Certain embodiments of the present invention may provide solutions to the problems and needs in the art that have not yet been fully identified, appreciated, or solved by current communications technologies, and/or provide a useful alternative thereto. For example, some embodiments of the present invention pertain to network optimization and repair using AI/ML.

In an embodiment, one or more computing systems include memory storing computer program instructions for repairing a RAN and at least one processor configured to execute the computer program instructions. The computer program instructions are configured to cause the at least one processor to receive telemetry data comprising traffic information, performance logs, and fault logs from a plurality of base stations of the RAN. The computer program instructions are also configured to cause the at least one processor to determine based on the telemetry data, by a RAN Intelligent Controller (RIC) using one or more AI/ML models, that an issue is occurring with equipment of the RAN. The computer program instructions are further configured to cause the at least one processor to directly or indirectly send control instructions to at least one base station of the plurality of base stations to implement a solution to the issue, by the RIC.

In another embodiment, one or more non-transitory computer-readable media store one or more computer programs for repairing a RAN. The one or more computer programs are configured to cause at least one processor to receive telemetry data comprising traffic information, performance logs, and fault logs from a plurality of base stations of the RAN. The one or more computer programs are also configured to cause the at least one processor to determine based on the telemetry data, by a RIC using one or more AI/ML models, that an issue is occurring with equipment of the RAN. The one or more computer programs are further configured to cause the at least one processor to directly or indirectly send control instructions to at least one base station of the plurality of base stations to implement a solution to the issue, by the RIC. The RAN has an Open RAN (O-RAN) architecture. The equipment on which the issue is occurring comprises one or more Radio Units (RUs), one or more Distributed Units (DUs), one or more Centralized Units (CUs), or any combination thereof.

In yet another embodiment, a computer-implemented method for repairing a RAN includes receiving telemetry data comprising traffic information, performance logs, and fault logs from a plurality of base stations of the RAN, by an rApp of a Non-Real Time (NRT) RIC executing on one or more computing systems. The computer-implemented method also includes determining using one or more AI/ML models, by the rApp of the NRT RIC, that an issue is occurring with equipment of the RAN. The computer-implemented method further includes directly or indirectly sending control instructions to at least one base station of the plurality of base stations to implement a solution to the issue, by the RIC. Additionally, the computer-implemented method includes sending a notification to a network engineer or a technician, by the rApp of the NRT RIC, indicating what the issue is and when the issue is predicted to cause a failure based on output from an AI/ML model of the one or more AI/ML models.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating an Open RAN (O-RAN), according to an embodiment of the present invention.

FIG. 2 is an architectural diagram illustrating a telecommunications system configured to perform network optimization and repair using AI/ML, according to an embodiment of the present invention.

FIG. 3 is an architectural diagram illustrating a network optimization and repair system, according to an embodiment of the present invention.

FIGS. 4A and 4B illustrate a cell site management scenario for a coverage area during a power outage, according to an embodiment of the present invention.

FIG. 5 is an architectural diagram illustrating a wireless telecommunications system, according to an embodiment of the present invention.

FIG. 6 is a flow diagram illustrating a process for performing network repair, according to an embodiment of the present invention.

FIG. 7 is a flow diagram illustrating a process for performing network power management during an outage, according to an embodiment of the present invention.

FIG. 8A illustrates an example of a neural network that has been trained to assist with performing network optimization and repair, proactive slice management, and predictive slice management using AI, according to an embodiment of the present invention.

FIG. 8B illustrates an example of a neuron, according to an embodiment of the present invention.

FIG. 9 is a flowchart illustrating a process for training AI/ML model(s), according to an embodiment of the present invention.

FIG. 10 is an architectural diagram illustrating a computing system configured to perform aspects of network optimization and repair using AI/ML, according to an embodiment of the present invention.

FIG. 11 is a flowchart illustrating a process for performing network repair, according to an embodiment of the present invention.

FIG. 12 is a flowchart illustrating a process for performing network power management during an outage, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to network optimization and repair using AI/ML. More specifically, AI/ML models are trained to predict hardware and software failures of RAN components (e.g., Radio Units (RUs), Distributed Units (DUs), Centralized Units (CUs), etc. in Open RAN (O-RAN)) by analyzing telemetry data. The telemetry data may include performance logs from performance monitors, fault logs from fault monitors, and traffic information for traffic flowing through the RAN. Hardware specifications of the RAN equipment, operating temperatures, power consumption, etc. may also be stored and monitored. This data may be monitored across the infrastructure, platform, and application layers. One or more rApps in a Non-Real Time RAN Intelligent Controller (NRT RIC) may use the AI/ML models to predict failures, and potentially, provide an indication of an estimated time when failure is predicted to occur.

The AI/ML models used by the rApp of the NRT RIC may flag network health reports, propose solutions, etc. Parameter mismatches may be suspected based on dropped calls as an indicator. The parameters of the respective equipment can be automatically modified in an attempt to correct the issue.

In O-RAN implementations, the RUs, DUs, and CUs may be monitored to predict potential failures. RUs are typically located at the cell sites. DUs may be located at the cell cites, in a Local Data Center (LDC), in a Breakout Edge Data Center (BEDC), etc. CUs are typically located in the LDC, BEDC, another carrier network data center, etc.

The key concept of O-RAN is “opening” the protocols and interfaces between the various building blocks (i.e., radios, hardware, and software) in the RAN. The O-RAN Alliance has defined various interfaces within the RAN, including those for fronthaul between the RU and the DU, midhaul between the DU and the CU, and backhaul connecting the RAN to the network core. The CU accommodates the higher protocol stack layers while the DU accommodates the lower protocol stack layers. The RU sends radio communications to and receives radio communications from User Equipment (UE) devices. The RU uses one or more frequency bands and has one or more antennas. RUs may vary from high-performance massive multiple-input, multiple-output (MIMO) systems that boost spectral efficiency through use of multi-antenna technologies to increase network coverage, capacity, and throughput to smaller, single antenna RUs (e.g., those associated with femtocells, picocells, and/or microcells, for example).

Consider the case of an RU that is experiencing a memory leak, struggling with performance in a given band, experiencing high levels of interference from another emitter, showing signs that a hardware failure will occur, etc. The rApp of the NRT RIC may detect the issue via the telemetry data that it receives from the telemetry data received from the respective Next-Generation Node B (gNB) of the RAN and send instructions to an xApp of a Near-Real Time (NRT) RIC via an A1 interface therebetween to communicate a solution to the RT RIC. The A1 interface enables communication between RT RIC 290 and NRT RIC 292. The A1 interface supports policy management, data transfer, and machine learning management. In other words, the NRT RIC instructs the RT RIC to implement corrections or corrective actions in the CU and/or DU. The gNB then implements the solution (e.g., moving users to different RUs, changing the frequency bands used by the troubled RU, changing beamforming characteristics for the RU, resetting the RU, any combination thereof, etc.).

Consider the case of an LDC of a RAN. If ten servers are running ten DUs in the LDC, the rApp monitors the health of each server using the telemetry data and the AI/ML models. For instance, the AI/ML models can be trained to monitor the fan speeds, temperatures, available Random Access Memory (RAM), call drops, packet loss rates, latency, etc. over time. If the fan speed is unexpected, the temperature is too high, the available RAM is shrinking and possibly indicative of a memory leak, etc., users being supported by the ailing DU server could be moved to one or more other DU servers. Alternatively, only high priority users may be moved if the RAN is congested. In some cases, a replacement DU for the failing DU may be brought up on an existing DU server (e.g., as DU software pods in Kubernetes® containers) if sufficient processing and memory resources are available, or a replacement DU may be spun up on a backup server if such a backup server exists at the LDC or another site that is sufficiently close to the cell site(s) managed by the DU for latency purposes. In some embodiments, remedial action can be taken for the problematic DU server in addition to or in lieu of the above, such as changing DU parameters, rebooting the DU server, etc. Network engineers may also be notified so failing or failed hardware of the DU server can be replaced, if needed.

Similarly, an rApp of the NRT RIC may monitor telemetry data for CUs using AI/ML models. If a CU is ailing, other CUs may be tasked with the functionality of the ailing CU, CU software for the ailing CU may be spun up on another server if sufficient processing and memory resources exist, etc. Network engineers may also be notified so failing or failed hardware of the CU server can be replaced, if needed.

In some embodiments, the AI/ML models learn to provide predictions for when failure of an RU, DU, or CU may occur. By training the AI/ML models using historical data and monitoring the RU/DU/CU using current telemetry data, the AI/ML models can learn to predict when failure is expected to occur and propose a solution accordingly. For instance, if hardware failure is expected to occur in two or three days, a technician can be dispatched to preemptively address the issue. If failure is expected in a shorter timeframe (e.g., within a few hours or otherwise before a technician can get to the ailing equipment), the AI/ML models may propose migrating users away from the ailing equipment, using different bands on the ailing equipment, instantiating a new instance of a DU or CU on another server, etc. If failure is imminent, the AI/ML models may send a high priority request to take remedial action and move higher priority users to different RUs, DUs, and/or CUs first, for example.

Some embodiments use AI/ML models to increase or maximize battery life during a power failure, such as those caused by a blackout, a natural disaster, etc. Traffic patterns from historical data may be used by the AI/ML models to predict when to put tower(s) to sleep, what frequency bands to use (e.g., only use band n71), what bands to shut down, where to migrate users, whether to run at lower capacity and what capacity to run at, whether to reduce Quality of Service (QOS), etc. The solution may become more strict as time goes on. For instance, capacity may be provided initially for predicted usage and cell sites may be rotated to preserve battery life. If a coverage area has 1,000 cell sites and 400 cell sites are sufficient to provide umbrella coverage, 600 cell sites may be in sleep mode and 400 cell sites may be actively serving users at a given time. During longer outages, as time goes on, the AI/ML models may become more aggressive in shutting down frequency bands and/or towers, may provide umbrella coverage for emergency calls only and drop or deny non-emergency calls, may allow emergency calls at a high QoS but provide a low QoS for other calls, may only allow users with a certain priority to make calls, etc.

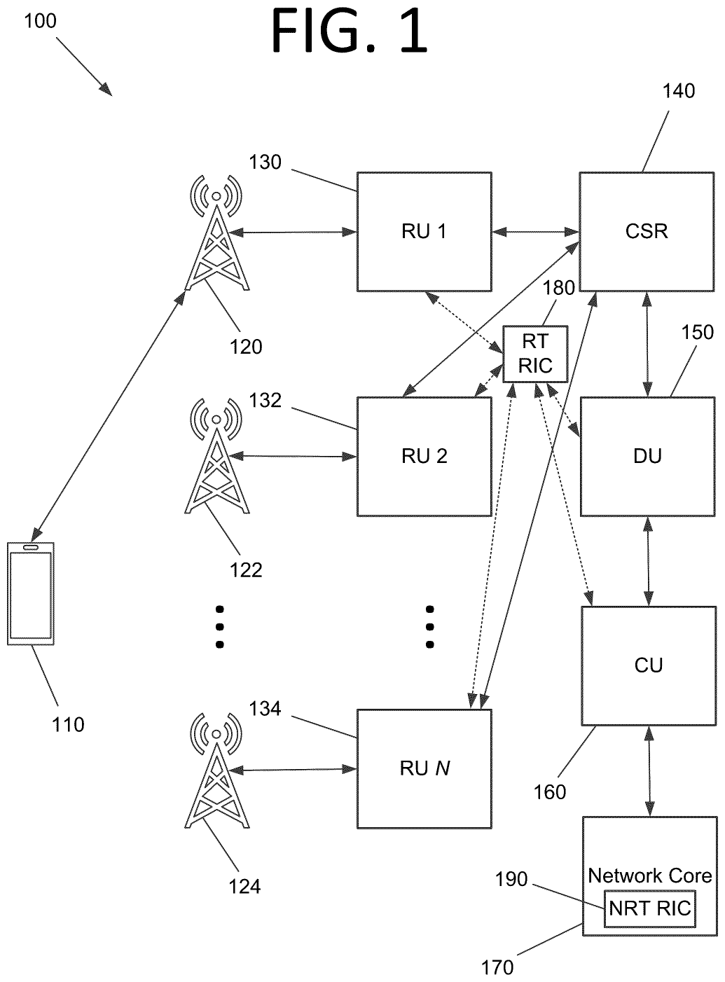

FIG. 1 is an architectural diagram illustrating an O-RAN 100, according to an embodiment of the present invention. In the O-RAN architecture, RAN 100 includes three main building blocks: NRUs 130, 132, . . . , 134, a DU 150 (although more than one DU may be included in RAN 100), and a CU 160 (although more than one CU may be included in RAN 100). Typically, there are more DUs than CUs in the O-RAN architecture.

In RAN 100, RUs 130, 132, . . . , 134 transmit, receive, amplify, and digitize radio frequency signals and are operably connected to and located near and/or integrated into N respective antennae 120, 122, . . . , 124 of their cell sites. Each cellular telecommunications tower may have multiple RUs of RUs 130, 132, . . . , 134 to fully service various bands for a particular coverage area. DU 150 receives the digitized radio signals from respective RUs 130, 132, . . . , 134 that it manages via a Cellular Site Router (CSR) 140 that routes traffic from RUs 130, 132, . . . , 134 to DU 150.

DUs are the main processing units that are responsible for the High Physical, Media Access Control (MAC), and Radio Link Control (RLC) protocols in the RAN protocol stack under the Third Generation Partnership Project (3GPP). In other words, DUs are a logical encapsulation of the 3GPP stack. In O-RAN or virtualized RAN (vRAN), DUs are typically servers based on an Intel® architecture that are optimized to run the real time RAN functions located below split 2 and to connect with the RUs through a fronthaul interface based on O-RAN split 7-2x. DUs perform Layer 1 (L1) and Layer 2 (L2) processing.

After performing High Physical, MAC, and RLC operations, DU 150 sends digitized radio signals to a CU 160 for further processing. CU 160 is responsible for non-real time, higher L2 and Layer 3 (L3) functions. CU 160 also controls the operation of DU 150.

CU 160 runs the Radio Resource Control (RRC) and Packet Data Convergence Protocol (PDCP) layers. The gNB may include CU 160 and DU 150, which is connected to CU 160 via Fs-C (control plane (CP)) and Fs-U (user plane (UP)) interfaces for the CP and UP, respectively. However, per the above, there are multiple DUs in RAN 100 in some embodiments. If CU 160 has multiple such DUs, CU 160 supports multiple gNBs. The split architecture allows a 5G network utilize different distributions of protocol stacks between CU 160 and its DUs, depending on midhaul availability and network design.

CU 160 is a logical node that includes gNB functions such as the transfer of user data, mobility control, RAN sharing (Multi-Operator RAN (MORAN)), positioning, session management etc., except for functions that are allocated exclusively to DU 150. CU 160 controls the operation of its DU(s) over the midhaul interface. In other words, CU 160 is connected to DU 150 via a midhaul link. CU 160 is also connected to a network core 170 via a backhaul link. Network core 170 is not technically part of RAN 100. In some embodiments, the backhaul link may be via satellite. Software of CU 160 can be co-located with DU software on the same server on site in some embodiments.

DU 150 is usually physically located at or near RUs 130, 132, . . . , 134 (e.g., at a cell site, in an LDC, in a BEDC if sufficiently proximate, etc.), whereas CU 160 can be located nearer to network core 170 (e.g., in a BEDC). In some cases, CU 160 may actually be located in network core 170. In some embodiments, DU 150 is offsite with respect to the cell site where respective RUs of RUs 130, 132, . . . , 134 are located, and DU 150 may be connected to CSR 140 by dark fiber, when available. For instance, dark fiber may connect CSR 140 to an LDC where DU 150 is housed. Alternatively, DU 150 may be located at the base of the cell site and connected to CU 160 via lit fiber.

A Near-Teal Time (NT) RIC 180 runs xApps that interact with RUs 130, 132, . . . , 134, DU, 150, and CU 160. In some embodiments, RT RIC 180 is running on the same computing system that is running DU 150 and/or CU 160. RT RIC 180 should be located close to RUs 130, 132, . . . , 134, DU, 150, and CU 160 since there are maximum latency constraints (e.g., 10 milliseconds to 1 second). Thus, RT RIC 180 may be located in an LDC or a BEDC if sufficiently proximate to these components. In some embodiments, RT RIC 180 may be where CU 160 is located or one level above CU 160 (controlling multiple CUs) and is part of the management entity for RAN 100.

Network core 170 includes an NRT RIC 190 that runs various rApps, typically with more than 1 second latency. These rApps can communicate with RUs 130, 132, . . . , 134, DU, 150, and/or CU 160 indirectly via the backhaul interface between CU 160 and network core 170. NRT RIC 190 may be located in a BEDC, a Regional Data Center (RDC), a National Data Center (NDC), etc.

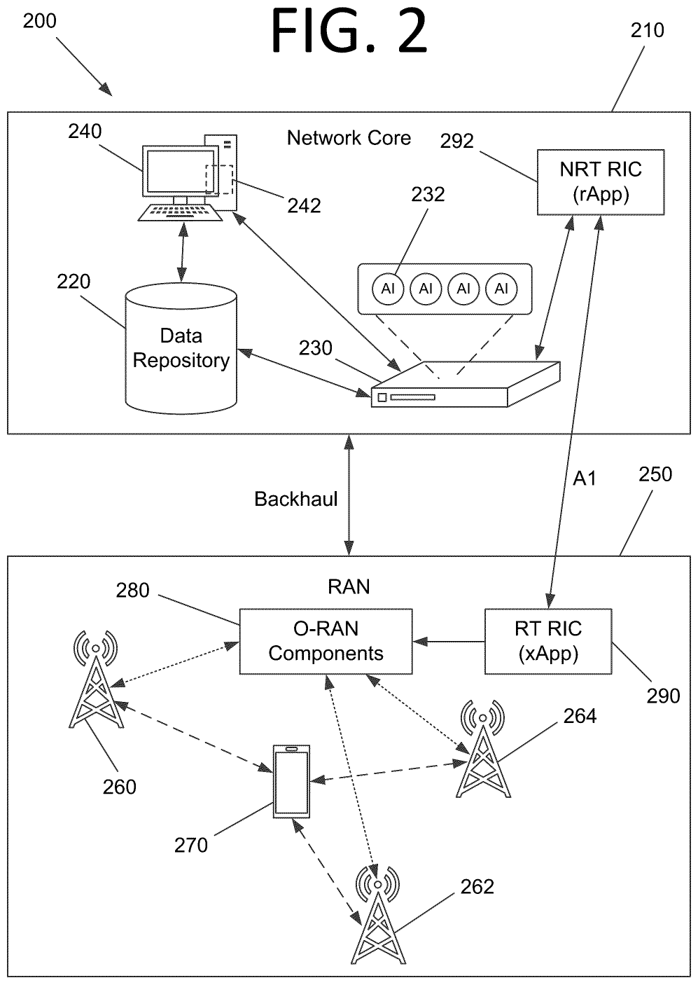

FIG. 2 is an architectural diagram illustrating a telecommunications system 200 configured to perform network optimization and repair using AI/ML, according to an embodiment of the present invention. Telecommunications system 200 includes a network core 210 and a RAN 250. In some embodiments, network core 210 and RAN 250 may be network core 170 and RAN 100 of FIG. 1. In this example, RAN 250 includes three cell sites 260, 262, 264 and UE 270 that communicates with cell sites 260, 262, 264. However, RAN 250 may have any number of cell sites depending on the requirements of the implementation. In some embodiments, some or all of O-RAN components 280 (e.g., RUs, DU(s), and CU(s)) may be located at cell sites 260, 262, and/or 264. O-RAN components 280 may include performance monitors and/or fault monitors.

Network core 210 provides higher level services for telecommunications system 200. Network core 210 may include BEDCs, RDCs, a NDC, etc. These data centers may be implemented in the cloud via dockerized clusters and run containerized Network Functions (NFs) in some embodiments. This allows service capacity to be spun up and spun down based on demand.

Network core 210 includes a data repository 220, servers 230, and training computing systems 240 in this embodiment. Network core 210 also includes an NRT RIC 292. In some embodiments, NRT RIC 292 may be located on servers 230. In certain embodiments, data repository 220 may be separate from network core 210 (e.g., provided by a third party cloud service provider).

Data repository 220 stores various information that is used for training AI/ML models 232 of servers 230. For instance, data repository 220 may store performance logs from performance monitors (e.g., temperatures, fan speeds, processor loads, memory usage, power consumption, health reports, performance reports, etc.), fault logs from fault monitors (e.g., software and/or hardware faults that occurred during operation of the respective equipment, dropped calls, etc.), traffic information for traffic flowing through the RAN (e.g., bit rates, bands, numbers of users, beamforming information, Signal-to-Noise Ratios (SNRs), Signal-to-Interference-plus-Noise Ratios (SINRs), jitter, etc.), equipment parameters (e.g., makes and models, types of hardware in the equipment and their capabilities, numbers and types of antennas, etc.), etc. Any suitable network, traffic, and/or equipment data may be used without deviating from the scope of the invention.

Labeling of data and/or training of AI/ML models 232 may be controlled by an AI management application 242 of training computing systems 240. Two or more of AI/ML models 232 may be chained in some embodiments (e.g., in series, in parallel, or a combination thereof) such that they collectively provide collaborative output(s). Using multiple AI/ML models may allow development of a more comprehensive picture of what is happening with respect to an application, for example. Patterns may be determined individually by an AI/ML model or collectively by multiple AI/ML models.

Each AI/ML model 232 is an algorithm that runs on the data, and the AI/ML model itself may be a deep learning neural network (DLNN) of trained artificial “neurons” that are trained on training data, for example. In some embodiments, AI/ML models 232 may have multiple layers that perform various functions, such as statistical modeling (e.g., hidden Markov models (HMMs)), and utilize deep learning techniques (e.g., long short term memory (LSTM) deep learning, encoding of previous hidden states, etc.) to perform the desired functionality. In order to train AI/ML models 232, training data (labeled, unlabeled, or both) from data repository 220 is used. AI/ML models 232 may be initially trained using this training data, and as new training data is available over time, one or more of AI/ML models 232 may be replaced with newly trained AI/ML models or be retrained to increase accuracy. Retraining may be performed in response to detecting data and/or model drift in some embodiments.

In some embodiments, generative AI models are used. Generative AI can generate various types of content, such as text, imagery, audio, and synthetic data. Various types of generative AI models may be used, including, but not limited to, LLMs, generative adversarial networks (GANs), variational autoencoders (VAEs), transformers, etc. These models may be part of AI/ML models 232 hosted on servers 230 in some embodiments. For instance, the generative AI models may be trained on a large corpus of information to perform semantic understanding, to understand bit rates that tend to be used by a given user profile, to understand the typical operating characteristics of the RANs in a given area, to learn typical congestion levels, etc.

In certain embodiments, generative AI models provided by an existing cloud ML service provider, such as OpenAIR, Google®, Amazon®, Microsoft®, IBM®, Nvidia®, Facebook®, etc., may be employed and trained to provide such functionality. These generative AI models may be accessed by servers 230 via the Internet. In generative AI embodiments where generative AI model(s) are remotely hosted, servers 230 can be configured to integrate with third-party Application Programming Interfaces (APIs), which allow servers 230 to send a request to the generative AI model(s) including the requisite input information and receive a response in return. Such embodiments may provide a more advanced and sophisticated user experience, as well as provide access to state-of-the-art natural language processing (NLP) and other ML capabilities that these companies offer.

One aspect of generative AI models in some embodiments is the use of transfer learning. In transfer learning, a pretrained generative AI mode, such as an LLM, is fine-tuned on a specific task or domain. This allows the LLM to leverage the knowledge already learned during its initial training and adapt it to a specific application. In the case of LLMs, the pretraining phase involves training an LLM on a large corpus of text, typically consisting of billions of words. During this phase, the LLM learns the relationships between words and phrases, which enables the LLM to generate coherent and human-like responses to text-based inputs. The output of this pretraining phase is an LLM that has a high level of understanding of the underlying patterns in natural language.

In the fine-tuning phase, the pretrained LLM is adapted to a specific task or domain by training the LLM on a smaller dataset that is specific to the task. For instance, in some embodiments, the LLM may be trained to analyze a certain type or multiple types of data sources to improve its accuracy with respect to their content. Such information may be provided as part of the training data, and the LLM may learn to focus on these areas and more accurately identify data elements therein. Fine-tuning allows the LLM to learn the nuances of the task or domain, such as the specific vocabulary and syntax used in that domain, without requiring as much data as would be necessary to train an LLM from scratch. By leveraging the knowledge learned in the pretraining phase, the fine-tuned LLM can achieve state-of-the-art performance on specific tasks with a relatively small amount of training data.

LLMs may be trained using a vector database in some embodiments. Vector databases index, store, and provide access to structured or unstructured data (e.g., text, images, time series data, etc.) alongside the vector embeddings thereof. Data such as text may be tokenized, where single letters, words, or sequences of words are parsed from the text into tokens. These tokens are then “embedded” into the vector embeddings, which are the numerical representations of this data. Vector databases allow software to find and retrieve similar objects quickly and at scale in production environments.

AI and ML allow unstructured data to be numerically represented without losing the semantic meaning thereof in vector embeddings. A vector embedding is a long list of numbers, each describing a feature of the data object that the vector embedding represents. Similar objects are grouped together in the vector space. In other words, the more similar the objects are, the closer that the vector embeddings representing the objects will be to one another. Similar objects may be found using a vector search, similarity search, or semantic search. The distance between the vector embeddings may be calculated using various techniques including, but not limited to, squared Euclidean or L2-squared distance, Manhattan or L1 distance, cosine similarity, dot product, Hamming distance, etc. It may be beneficial to select the same metric that is used to train the AI/ML model.

Vector indexing may be used to organize vector embeddings so data can be retrieved efficiently. Calculating the distance between a vector embedding and all other vector embeddings in the vector database using the k-Nearest Neighbors (kNN) algorithm can be computationally expensive if there are a large number of data points since the required calculations increase linearly (i.e., O(n)) with the dimensionality and the number of data points. It is more efficient to find similar objects using an approximate nearest neighbor (ANN) approach. The distances between the vector embeddings are pre-calculated, and similar vectors are organized and stored close to one another (e.g., in clusters or a graph) similar objects can be found faster. This process is called “vector indexing.” ANN algorithms that may be used in some embodiments include, but are not limited to, clustering-based indexing, proximity graph-based indexing, tree-based indexing, hash-based indexing, compression-based indexing, etc.

Once AI/ML models 232 have been trained, an rApp of NRT RIC 292, using AI/ML models 232, monitors the information stored in data repository 220. In some embodiments, the information that is monitored may be in a time window (e.g., the last minute, the last ten minutes, the last hour, the last day, etc.). Individual models may be trained for certain purposes. For instance, one AI/ML model may monitor temperatures, another may monitor fan speeds, yet another may monitor power consumption, etc.

By running the information from data repository 220 through their logic, AI/ML models 232 are able to determine that an issue may be occurring with an RU, a DU, or a CU of O-RAN components 280 with a certain confidence score. For instance, an AI/ML model that has been trained to detect anomalous processor temperatures may determine that a DU will fail in two hours with an 80% confidence score. The rApp of NRT RIC 292 instructs the appropriate xApp of RT RIC 290 to address the issue via an A1 interface. RT RICs run the low latency timescale control loop logic operating on a timescale between 10 milliseconds (ms) and 1 second, whereas NRT RICs can run on longer timescales. The xApp of RT RIC 290, via an E2 interface, then instructs the gNB associated with the DU that is likely to fail to perform the corrective action.

Various other operations may be controlled by the xApp of RT RIC 290 by sending control instructions to gNB(s) via the E2 interface including, but not limited to, changing parameters of O-RAN components 280, porting the functionality of one RU, DU, or CU to another RU, DU, or CU, spinning up a new instance of a DU or CU on a new server, moving users between RUs, DUs, and/or CUs, switching bands, changing beamforming configurations, reducing the number of bands that are used, reducing the number of cell sites that are used, moving users from one cell site to another, putting cell sites into sleep mode, dispatching a technician to repair or replace equipment, resetting a RU, DU, or CU, instantiating a new instance of the RU, DU, or CU software on the same equipment, reducing RAN bit rates, reducing QoS for at least some users, only allowing calls by users with at least a certain priority, any combination thereof, etc. The xApp uses platform services available in RT RIC 290 to communicate with the appropriate downstream NFs through the respective E2 interface, which is a network interface carrying events, control, and policy information to the O-RAN NFs. The downstream NFs can be gNB O-DU, gNB O-CU-CP, gNB O-CU-UP, and/or O-eNB, for example. The E2 interface allows southbound nodes setup the E2 interface and register the list of applications the southbound nodes support, allows xApps running in NT RIC 290 to subscribe for events from the southbound nodes (e.g., as prescribe an action to execute upon encountering an event, such as report the event, report and wait for further control instructions from the xApp, or execute a policy), and provides control instructions.

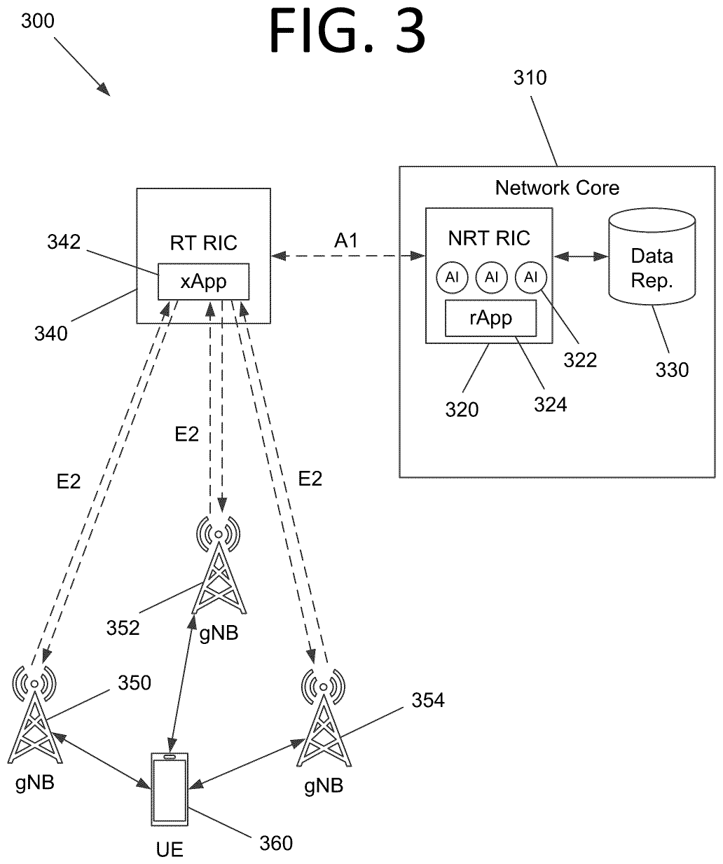

FIG. 3 is an architectural diagram illustrating a network optimization and repair system 300, according to an embodiment of the present invention. gNBs 350, 352, 354 run performance monitors and fault monitors. Performance logs from the performance monitors.), fault logs from the fault monitors, traffic information for traffic flowing through the RAN, equipment parameters, etc. are collected by gNBs 350, 352, 354 and provided to a data repository 330 of a network core 310. However, in some embodiments data repository 330 may be outside of network core 330 (e.g., hosted by a third party cloud service provider). This information is used by an NRT RIC 320 to train AI/ML models 322.

Once trained, an rApp 324 of NRT RIC 320 uses AI/ML models 322 to monitor the performance of RAN equipment (e.g., RUs, DUs, CUs, etc.). When an issue is detected, rApp 324 sends a solution for the detected issue to an xApp 342 of an RT RIC 340 via an A1 interface. xApp 342 and RT RIC 340 communicate with gNBs 350, 352, 354 via E2 interfaces. xApp 342 then sends control information to one or more of gNBs 350, 352, 354 via the E2 interface(s). The respective gNB(s) of gNBs 350, 352, 354 then implement the solution in the respective RU(s), DU(s), and/or CU(s) that are experiencing the issue.

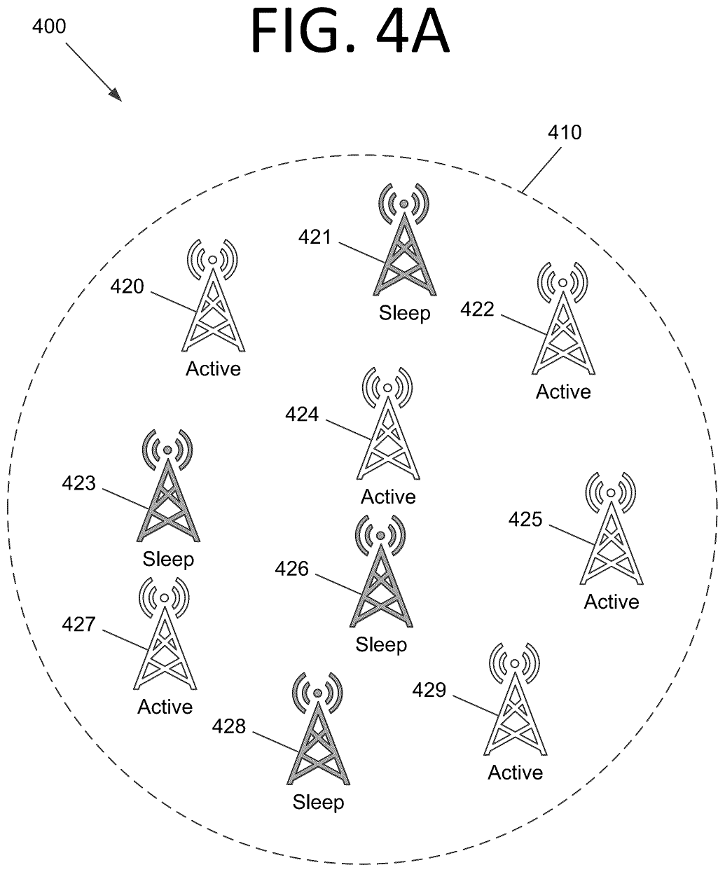

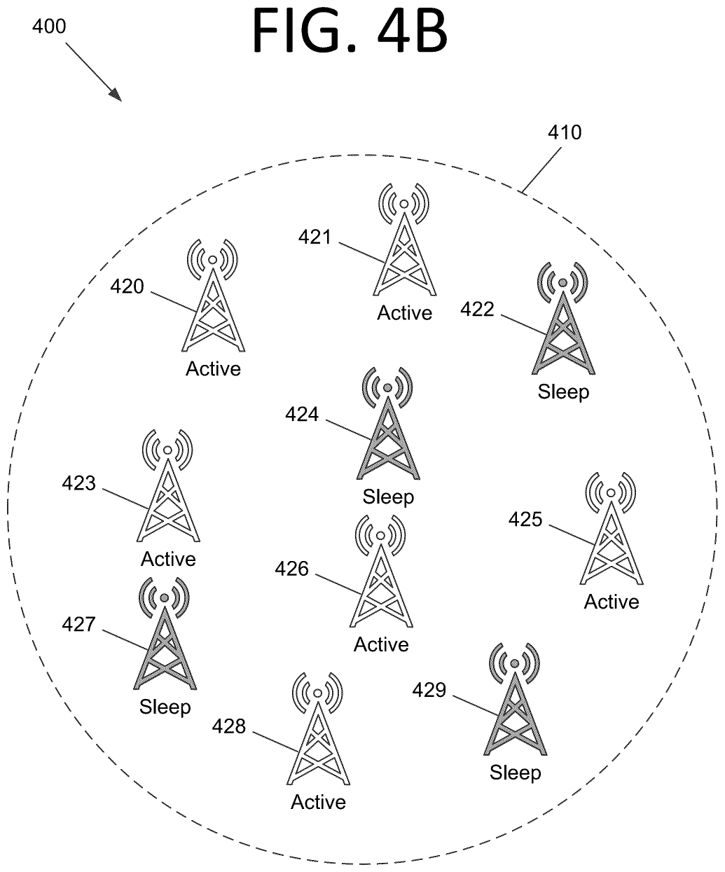

FIGS. 4A and 4B illustrate a cell site management scenario 400 for a coverage area 410 during a power outage, according to an embodiment of the present invention. Coverage area 410 has ten cell sites 420-429. Cell sites 420, 422, 424, 425, 427, 429 are active and cell sites 421, 423, 426, 428 are in sleep mode initially in FIG. 4A. For instance, AI/ML models used by an rApp of an NRT RIC may have determined that the power is out in the coverage area and that the coverage area can be serviced by a subset of the cell towers. Accordingly, the rApp caused call sites 421, 423, 426, 428 to be powered down in FIG. 4A. In order to conserve power for the overall network, after a time period has passed or after battery power for cell sites 420, 422, 424, 425, 427, 429 has dropped by a certain amount, the rApp causes cell sites 421, 423, 426, 428 to switch to active mode and causes cell sites 422, 424, 427, 429 to enter sleep mode in FIG. 4B.

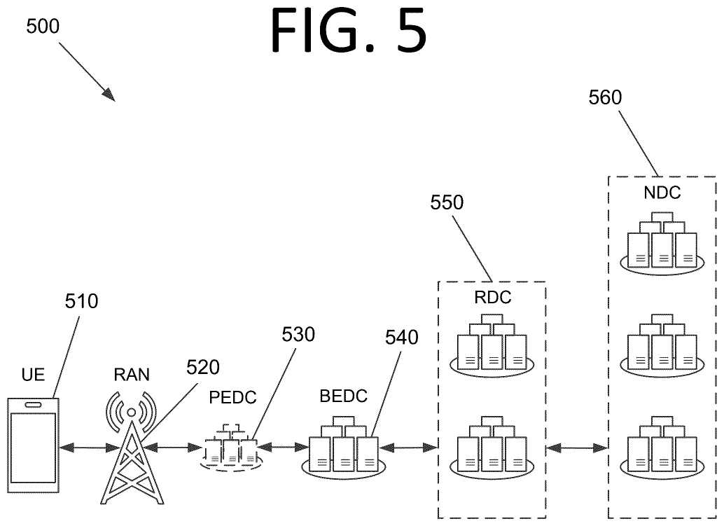

FIG. 5 is an architectural diagram illustrating a wireless telecommunications system 500, according to an embodiment of the present invention. UE 510 (e.g., a mobile phone, a tablet, a laptop computer, a smart watch, etc.) communicates with a RAN 520. In some embodiments, RAN 520 may be a 5G New Radio O-RAN implementation where cell sites include antennas operably connected to RUs, which are operably connected to a DU, which, in turn, is operably connected to a CU.

RAN 520 sends communications to UE 510, as well as from UE 510 further into the carrier network. In some embodiments, communications are sent to/from RAN 520 via a PEDC 530 to provide lower latency. However, in some embodiments, RAN 520 communicates directly with a BEDC 540. In some embodiments, the DU and/or CU are located in an LDC (not shown) and/or BEDC 340. BEDCs are typically smaller data centers that are proximate to the populations they serve. BEDCs may break out User Plane Function data traffic (UPF-d) and provide cloud computing resources and cached content to UE 510, such as providing NF application services for gaming, enterprise applications, etc.

The carrier network may provide various NFs and other services. For instance, BEDC 540 may provide cloud computing resources and cached content to UE 510, such as providing NF application services for gaming, enterprise applications, etc. An RDC 550 may provide core network functions, such as UPF voice traffic (UPF-v), UPF-d (if not in BEDC 540, for example), Session Management Function (SMF), and Access and Mobility Management Function (AMF) functionality. The SMF includes Packet Data Network Gateway (PGW) Control Plane (PGW-C) functionality. The UPF includes PGW User Data Plane (PGW-U) functionality.

An NDC 560 may provide Unified Data Repository (UDR) and user verification services, for example. Other network services that may be provided may include, but are not limited to, Internet Protocol (IP) Multimedia Subsystem (IMS)+Telephone Answering Service (TAS), IP-SM Gateway (IP-SM-GW) (the network functionality that provides the messaging service in the IMS network), Enhanced Serving Mobile Location Center (E-SMLC) for former generation wireless networks, Gateway Mobile Location Center (GMLC), Location Retrieval Function (LRF), Location Management Function (LMF), Home Location Register (HLR), Home Subscriber Server (HSS), Unified Data Management (UDM), Authentication Server Function (AUSF), Unified Data Repository (UDR), Short Message Service Center (SMSC), PCF, Mobile Edge Computing (MEC), Network Exposure Functions (NEFs) or Common API Framework (CAPIF) for Third Generation Partnership Project (3GPP) northbound APIs, Network Slice Selection Function (NSSF), Non-3GPP InterWorking Function (N3IWF), Network Data Analytics Function (NWDAF), Mediation and Delivery Function (MDF), Service Communication Proxy (SCP), and/or Security Edge Protection Proxy (SEPP) functionality. It should be noted that additional and/or different network functionality may be provided without deviating from the present invention. The various functions in these systems may be performed using dockerized clusters in some embodiments.

BEDC 540 may utilize other data centers for NF authentication services. RDC 550 receives NF authentication requests from BEDC 540. RDC 550 may help with managing user traffic latency, for instance. However, RDC 550 may not perform NF authentication in some embodiments.

From RDC 550, NF authentication requests may be sent to NDC 560, which may be located far away from UE 510, RAN 520, PEDC 530, BEDC 540, and RDC 550. User verification may be performed at NDC 560. An AI/ML system that performs the various AI functionality described herein may be located in BEDC 340, RDC 350, any combination thereof, etc. (e.g., in an NRT RIC thereof). In some embodiments, one or more of the AI/ML models may be external to the network and accessed by network computing systems via the Internet.

It should be noted that wireless telecommunications system 500 of FIG. 5 is only one of multiple possible network configurations. For instance, if a cell site of RAN 520 is located in the same city as RDC 550, RAN 520 may connect directly to RDC 550. Any suitable network configuration may be used without deviating from the scope of the invention.

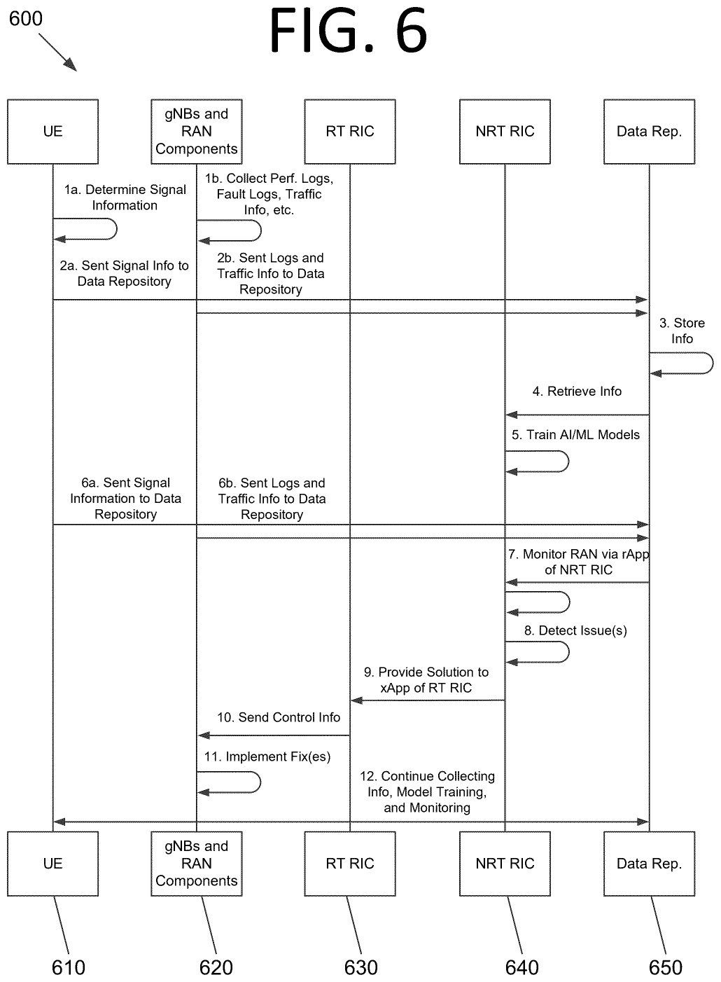

FIG. 6 is a flow diagram illustrating a process 600 for performing network repair, according to an embodiment of the present invention. UE 610 and other UE devices determine signal information for the cell sites of a RAN. gNBs 620 of the RAN collect performance logs, fault logs, traffic information, equipment parameters, etc. for their respective cell sites. The collected information is sent to and stored in a data repository 650.

An NRT RIC 640 retrieves the information from data repository 650 and uses this information to train AI/ML models. UE 610 and other UE devices and gNBs 620 keep data repository 650 updated with recent performance information. Once trained, an rApp of NRT RIC 640 monitors RUs, DUs, CUs, etc. of the RAN using data from data repository 650 and the AI/ML models. In some embodiments, the information that is monitored may be in a time window (e.g., the last minute, the last ten minutes, the last hour, the last day, etc.). Individual models may be trained for certain purposes. For instance, one AI/ML model may monitor temperatures, another may monitor fan speeds, yet another may monitor power consumption, etc.

The rApp of NRT RIC 640 determines that one or more issues are occurring in equipment of the RAN using the AI/ML models. The rApp of NRT RIC 640 provides a solution to an xApp of an RT RIC 630 via an A1 interface. The rApp may also inform network engineers that the issue(s) are occurring. RT RIC 630 then sends control information to gNB(s) 620 to make the changes for the solution. gNB(s) 620 implement the fix(es), and the process of collecting information, retraining the AI/ML models, and monitoring the RAN continues.

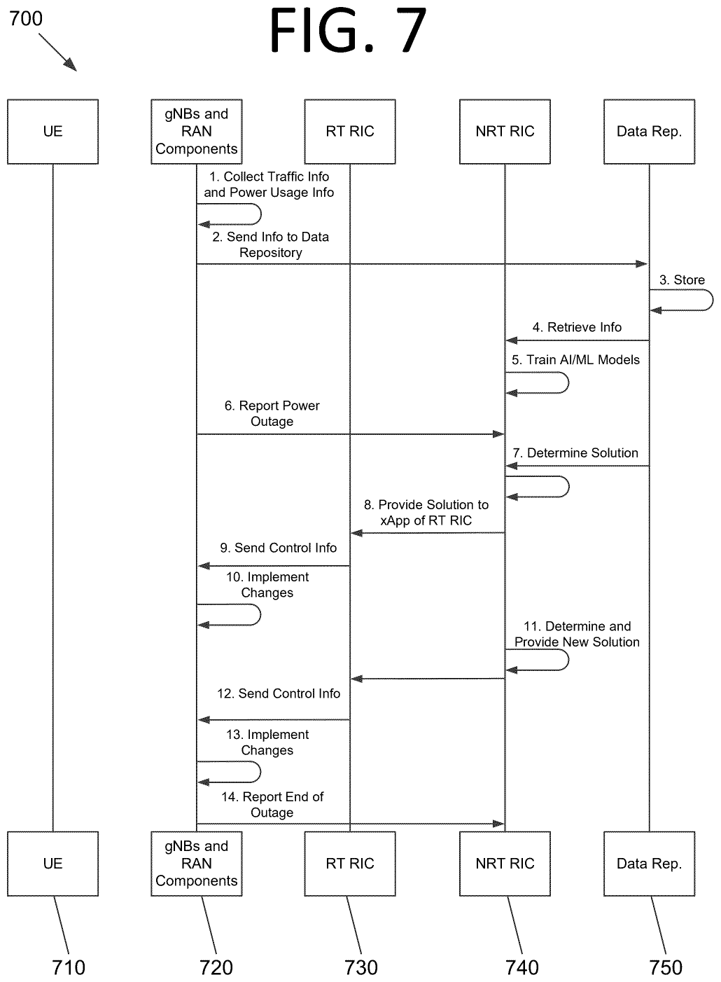

FIG. 7 is a flow diagram illustrating a process 700 for performing network power management during an outage, according to an embodiment of the present invention. Like FIG. 6, process 700 involves UE 710, gNBs and RAN components 720, an RT RIC 730, an NRT RIC 740, and a data repository 750. gNBs 720 of the RAN collect traffic information and power usage information for their respective cell sites. This information may include the number of users that a cell site is serving at a given time, the network usage for these users, the power consumption of the RAN equipment at those times, etc. The collected information is sent to and stored in a data repository 750.

An NRT RIC 740 retrieves the stored information from data repository 750 and uses this information to train AI/ML models. For instance, the AI/ML models may learn traffic patterns, network congestion patterns, associated power consumption, etc. A power outage then occurs, and gNB(s) 620 that are affected report the cell site(s), RUs, DU(s), and/or CU(s) that are affected. An rApp NRT RIC 740 uses the AI/ML models to determine a solution. For instance, the rApp of NRT RIC 740 may determine that one or more cell sites should be put into sleep mode, that the number of bands should be reduced, that QoS should be reduced, that only certain users should be permitted to use the network, etc. The rApp of NRT RIC 740 provides the solution to an xApp of an RT RIC 730 via an A1 interface. The rApp may also inform network engineers that the solution is being implemented, where the power outage is, etc. RT RIC 730 then sends control information to gNB(s) 720 to make the changes for the solution. gNB(s) 720 implement the changes, and the rApp of NRT RIC 740 continues to monitor network performance, battery power levels, etc.

After a period of time, a more aggressive solution is required. For instance, the power outage may have lasted long enough that cell site battery levels are getting low. The rApp of NRT RIC 740 then determines a more aggressive solution using the AI/ML models and sends this solution to the xApp of RT RIC 730. For instance, the rApp and AI/ML models may determine that more cell sites should be put into sleep mode, what lower priority and/or cheaper subscription users should not be permitted to use the network, that only emergency personnel should be able to use the network, etc. RT RIC 730 then sends control information to gNB(s) 720 to make the changes for the solution. gNB(s) 720 implement the changes, and the rApp of NRT RIC 740 continues to monitor network performance, battery power levels, etc. The process of monitoring the network and making progressively more aggressive changes may continue until the power outage ends.

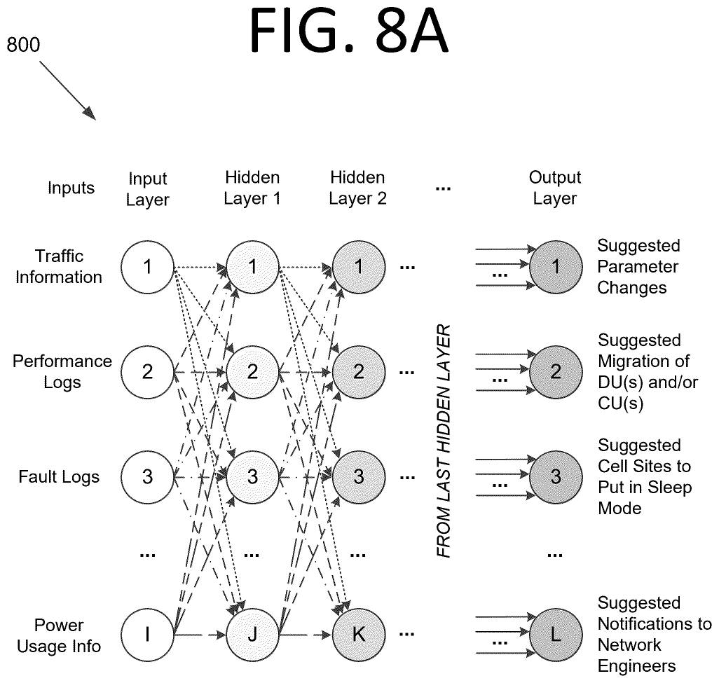

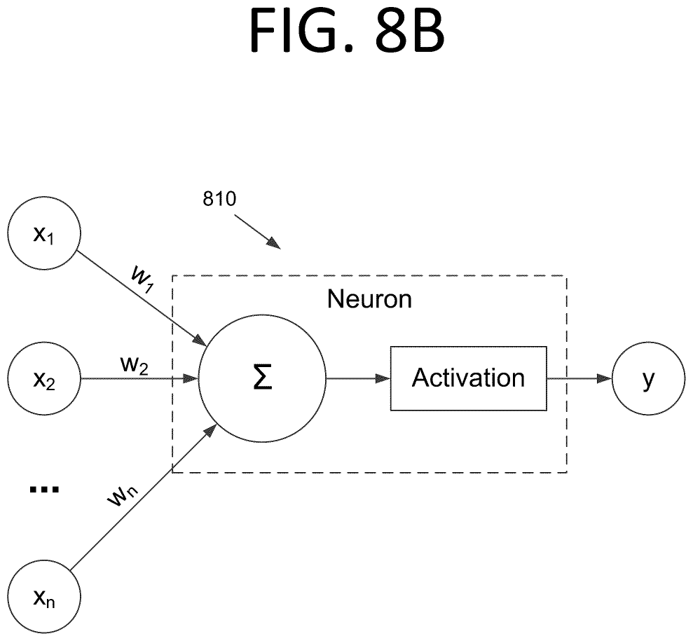

Per the above, AI/ML may be used in some embodiments. Various types of AI/ML models may be trained and deployed without deviating from the scope of the invention. For instance, FIG. 8A illustrates an example of a neural network 800 that has been trained to assist with performing network optimization and repair, proactive slice management, and predictive slice management using AI, according to an embodiment of the present invention.

Neural network 800 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 800.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 8A, traffic information, performance logs, fault logs, power usage information, equipment information, etc. provided as the input layer are fed as inputs to the J neurons of hidden layer 1. Various information may be included in this context, such as temperatures, fan speeds, processor loads, memory usage, power consumption, health reports, performance reports, software and/or hardware faults that occurred during operation of the respective equipment, dropped calls, bit rates, bands, numbers of users, beamforming information, SNRs, SINRs, jitter, equipment makes and models, types of hardware in the equipment and their capabilities, numbers and types of antennas, etc.), etc. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. In this example, the outputs may be suggested parameter changes, suggested migration of DU(s) and/or CU(s), suggested cell sites to put to sleep, suggested notifications to network engineers, etc. It should be noted that numbers of neurons I, J, K, and L are not necessarily equal, and thus, any desired number of layers may be used for a given layer of neural network 800 without deviating from the scope of the invention. Indeed, in certain embodiments, the types of neurons in a given layer may not all be the same. For instance, convolutional neurons, recurrent neurons, and/or transformer neurons may be used.

Neural network 800 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

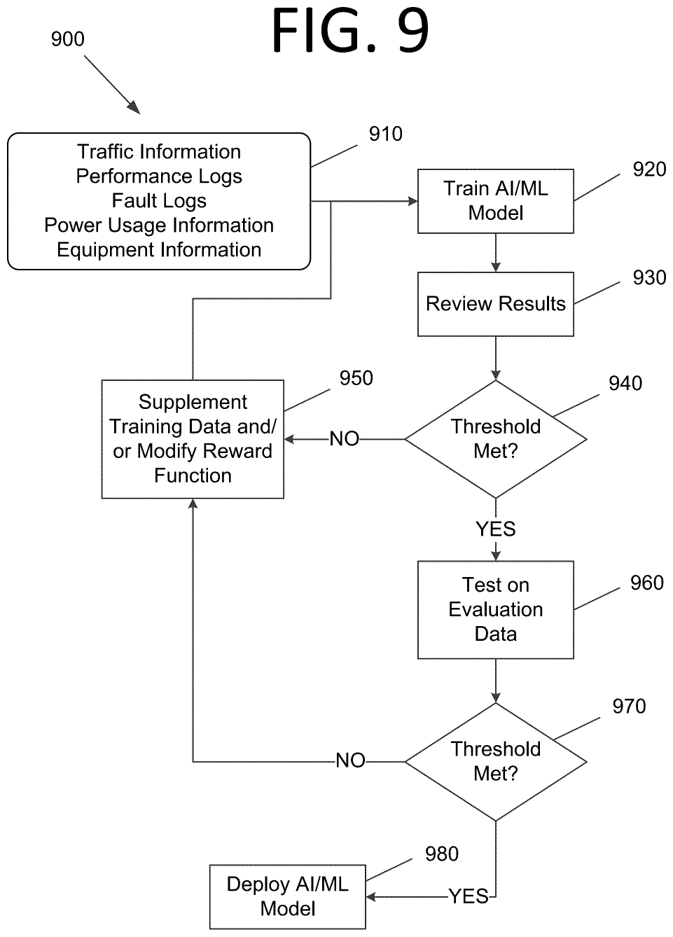

An example of a neuron 810 is shown in FIG. 9B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 810 may thus be given by:

$$y = f ( x ) {\sum }_{i = 1}^{m} ( {w}_{i} {x}_{i} ) + bias \qquad ( 3 )$$

In this case, neuron 810 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the best core for a give service or application, determining when a network associated with a core is likely to be congested, etc.).

During training, various labeled data is fed through neural network 800. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o-t. This global error is then propagated backwards giving local errors for weight updates with computations similar to, but not exactly the same as, those used for forward propagation. In particular, the backpropagation step typically requires an activity function of the form pⱼ(nⱼ)=f′ⱼ(nⱼ), where nⱼ is the network activity at layer j (i.e., nⱼ=Wⱼoⱼ₋₁+bⱼ) where oⱼ=fⱼ(nⱼ) and the apostrophe ' denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{n e w} = {W}_{j}^{o l d} - η \frac{\partial E}{\partial {W}_{j}} \qquad ( 8 )$$

$${b}_{j}^{n e w} = {b}_{j}^{o l d} - η \frac{\partial E}{\partial {b}_{j}} \qquad ( 9 )$$

where ∘ denotes a Hadamard product (i.e., the element-wise product of two vectors), T denotes the matrix transpose, and oⱼ denotes fⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

Natural language processing (NLP) techniques such as word2vec, BERT, GPT-3, ChatGPT, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

FIG. 9 is a flowchart illustrating a process 900 for training AI/ML model(s), according to an embodiment of the present invention. The process begins with providing traffic information, performance logs, fault logs, power usage information, equipment information, etc. at 910, whether labeled or unlabeled. Other training data used in addition to or in lieu of the training data shown in FIG. 9. Indeed, the nature of the training data that is provided will depend on the objective that the AI/ML model is intended to achieve. The AI/ML model is then trained over multiple epochs at 920 and results are reviewed at 930.

If the AI/ML model fails to meet a desired confidence threshold at 940, the training data is supplemented and/or the reward function is modified to help the AI/ML model achieve its objectives better at 950 and the process returns to step 920. If the AI/ML model meets the confidence threshold at 940, the AI/ML model is tested on evaluation data at 960 to ensure that the AI/ML model generalizes well and that the AI/ML model is not over fit with respect to the training data. The evaluation data includes information that the AI/ML model has not processed before. If the confidence threshold is met at 970 for the evaluation data, the AI/ML model is deployed at 980. If not, the process returns to step 950 and the AI/ML model is trained further.

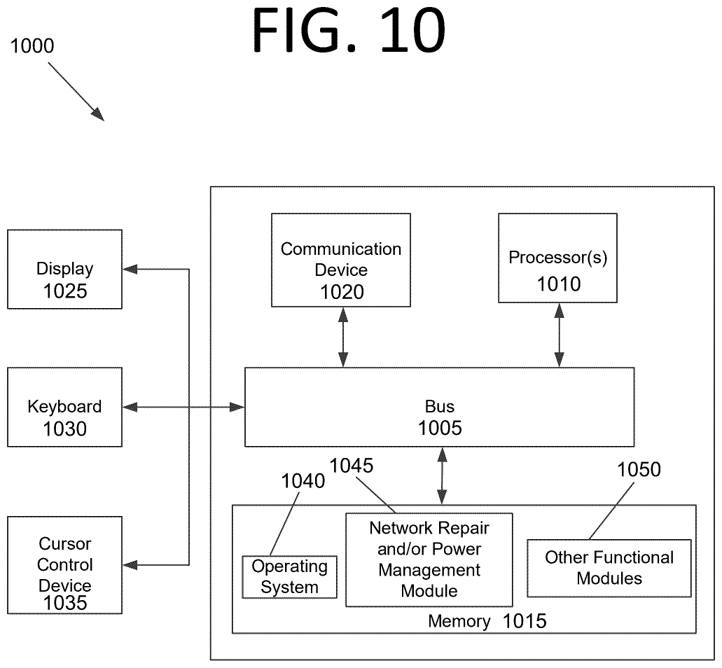

FIG. 10 is an architectural diagram illustrating a computing system 1000 configured to perform aspects of network optimization and repair using AI/ML, according to an embodiment of the present invention. In some embodiments, computing system 1000 may be one or more of the computing systems depicted and/or described herein, such as a mobile device, a tablet, a laptop computer, a smart watch, a carrier network computing system (e.g., a computing system of a RAN, a PEDC, a BEDC, an RDC, or an NDC), a computing system of a data lake, etc. Computing system 1000 includes a bus 1005 or other communication mechanism for communicating information, and processor(s) 1010 coupled to bus 1005 for processing information. Processor(s) 1010 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1010 may also have multiple processing cores, and at least some of the cores may be configured to perform specific functions. Multi-parallel processing may be used in some embodiments. In certain embodiments, at least one of processor(s) 1010 may be a neuromorphic circuit that includes processing elements that mimic biological neurons. In some embodiments, neuromorphic circuits may not require the typical components of a Von Neumann computing architecture.

Computing system 1000 further includes a memory 1015 for storing information and instructions to be executed by processor(s) 1010. Memory 1015 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1010 and may include volatile media, non-volatile media, or both. The media may also be removable, non-removable, or both.

Additionally, computing system 1000 includes a communication device 1020, such as a transceiver, to provide access to a communications network via a wireless and/or wired connection. In some embodiments, communication device 1020 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), 5G, New Radio (NR), any combination thereof, and/or any other currently existing or future-implemented communications standard and/or protocol without deviating from the scope of the invention. In some embodiments, communication device 1020 may include one or more antennas that are singular, arrayed, phased, switched, beamforming, beamsteering, a combination thereof, and or any other antenna configuration without deviating from the scope of the invention.

Processor(s) 1010 are further coupled via bus 1005 to a display 1025, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 1025 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 1030 and a cursor control device 1035, such as a computer mouse, a touchpad, etc., are further coupled to bus 1005 to enable a user to interface with computing system 1100. However, in certain embodiments, a physical keyboard and mouse may not be present, and the user may interact with the device solely through display 1025 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1015 stores software modules that provide functionality when executed by processor(s) 1010. The modules include an operating system 1040 for computing system 1000. The modules further include a network repair and/or power management module 1045 that is configured to perform all or part of the processes described herein or derivatives thereof. Computing system 1000 may include one or more additional functional modules 1050 that include additional functionality.

One skilled in the art will appreciate that a “computing system” could be embodied as a server, an embedded computing system, a personal computer, a console, a cell phone, a tablet computing device, a smart watch, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

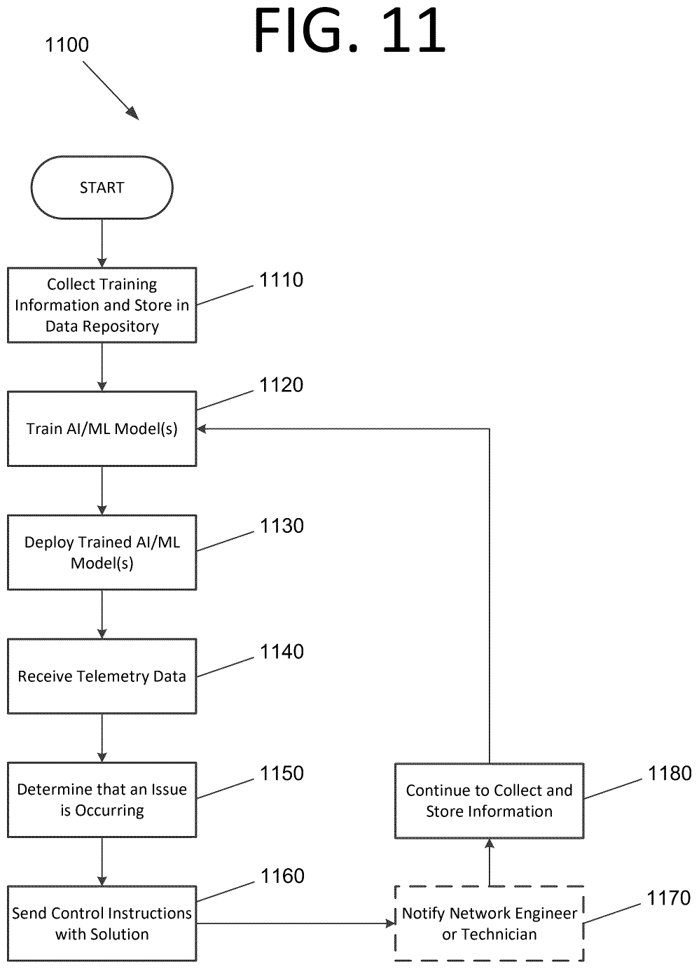

FIG. 11 is a flowchart illustrating a process 1100 for performing network repair, according to an embodiment of the present invention. The process begins with storing training data including traffic information, performance logs, and fault logs (e.g., telemetry data) and equipment information for RAN hardware in a data repository at 1110. In some embodiments, the telemetry data and/or equipment information includes temperatures, fan speeds, processor loads, memory usage, power consumption, health reports, performance reports, software and/or hardware faults that occurred during operation of respective equipment, dropped calls, bit rates, bands, numbers of users, beamforming information, SNRs, SINRs, jitter, makes and models of the equipment, types of hardware in the equipment and their capabilities, numbers and types of antennas, or any combination thereof. One or more AI/ML models are trained using the stored telemetry data and the equipment information from the data repository at 1120. In some embodiments, the training is performed by an NRT RIC or another application of a network core. The one or more trained AI/ML models are then deployed for monitoring the RAN at 1130. In some embodiments, the AI/ML model(s) are trained to monitor fan speeds of the equipment, temperatures of the equipment, available RAM for the equipment, call drops by the equipment, packet loss rates for the equipment, latency for the equipment, or any combination thereof, over a time period.

Recent telemetry data is received from base stations of the RAN at 1140. An NRT RIC uses the AI/ML model(s) to determine based on the telemetry data that an issue is occurring with equipment of the RAN at 1150. The NRT RIC then directly or indirectly sends control instructions to at least one base station via an E2 interface to implement a solution to the issue at 1160. In some embodiments, the NRT RIC also sends a notification to a network engineer or a technician indicating what the issue is and when the issue is predicted to cause a failure at 1170. The system continues to collect and store network information in the data repository at 1180. When a predetermined amount of time has elapsed, after a predetermined amount of data is collected, at the command of a network engineer, etc., the process returns to step 1120. Specifically, the AI/ML model(s) are retrained and/or new AI/ML model(s) are trained using the stored telemetry data from the data repository by the NRT RIC or the other application of the network core. The retrained and/or new models are then deployed at 1130 and the process repeats.

In some embodiments, the RAN has an O-RAN architecture and the equipment on which the issue is occurring includes one or more RUs, one or more DUs, one or more CUs, or any combination thereof. In certain embodiments, an rApp of the NRT RIC is configured to send the solution to an RT RIC via an A1 interface and the xApp of the RT RIC is configured to directly send the control instructions to at least one base station via an E2 interface to implement the solution to the issue. In some embodiments, issue includes parameter mismatches and the control instructions comprise changes to the parameters of one or more RUs, one or more DUs, one or more CUs, or any combination thereof. In certain embodiments, the control instructions include instructions to reset an RU, move users to one or more other RUs, change frequency bands used by the RU, change beamforming characteristics for the RU, any combination thereof. In some embodiments, the control instructions include instructions to instantiate a new instance of software for a DU or a CU on the DU or the CU. In certain embodiments, the control instructions include instructions to migrate a DU or a CU to a different server.

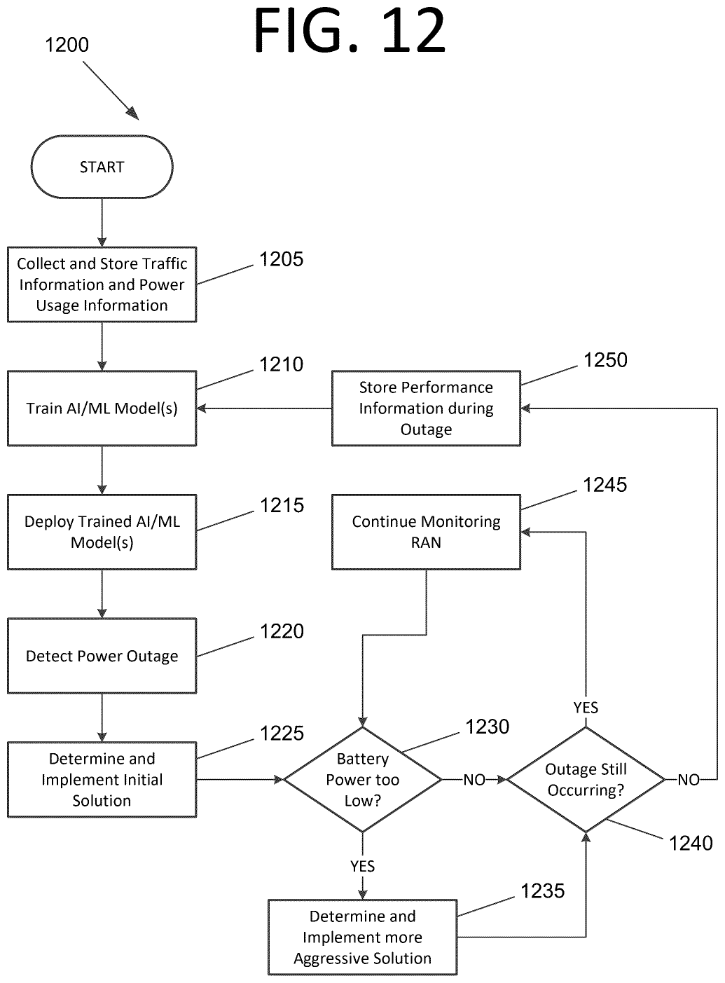

FIG. 12 is a flowchart illustrating a process 1200 for performing network power management during an outage, according to an embodiment of the present invention. The process begins with collecting and storing traffic information and power usage information (e.g., the amount of power consumed by RAN equipment under different network loads and operating conditions, battery capacity, battery life estimates, etc.) for cell sites of a RAN in a data repository at 1205. An NRT RIC retrieves the stored information from the data repository and uses this information to train AI/ML models at 1210. For instance, the AI/ML models may learn traffic patterns, network congestion patterns, associated power consumption, etc. The trained AI/ML models are then deployed at 1215.

A power outage is detected at 1220, including affected cell sites and other RAN equipment. The NRT RIC, using the AI/ML models, determines and implements an initial solution to reduce power consumption by the cell sites of the RAN at 1225. For instance, the NRT RIC may determine that one or more cell sites should be put into sleep mode, that the number of bands should be reduced, that QoS should be reduced, that only certain users should be permitted to use the network, etc. The NRT RIC may also inform network engineers that the solution is being implemented, where the power outage is, etc.

As time goes on, the battery levels of the cell sites drop. If the available battery power is getting too low for the initial solution at 1230, the NRT RIC and AI/ML models determine and implement a more aggressive solution at 1235. For instance, the NRT RIC and AI/ML models may determine that more cell sites should be put into sleep mode, what lower priority and/or cheaper subscription users should not be permitted to use the network, that only emergency personnel should be able to use the network, etc. If the outage is still occurring at 1240, the NRT RIC and AI/ML models continue monitoring the RAN at 1245.

If the outage is over at 1245, information collected during the outage is stored in the data repository at 1250. For instance, the collected information may include actions that were taken for each solution during the outage, battery usage levels, traffic characteristics, comparisons of traffic characteristics to typical characteristics, whether the solutions were able to maintain complete coverage and in what areas, etc. The process then returns to step 1210. Specifically, the AI/ML model(s) are retrained and/or new AI/ML model(s) are trained using the stored performance data so future outages will be handled more effectively. The retrained and/or new models are then deployed at 1215 and the process repeats during the next power outage.

The process steps performed in FIGS. 6, 7, 9, 11, and 12 may be performed by computer program(s), encoding instructions for the processor(s) to perform at least part of the process(es) described in FIGS. 6, 7, 9, 11, and 12, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 1010 of computing system 1000 of FIG. 10) to implement all or part of the process steps described in FIGS. 6, 7, 9, 11, and 12, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more computing systems, comprising:
memory storing computer program instructions for repairing a Radio Access Network (RAN); and
at least one processor configured to execute the computer program instructions, wherein the computer program instructions are configured to cause the at least one processor to:
receive telemetry data comprising traffic information, performance logs, and fault logs from a plurality of base stations of the RAN,
determine based on the telemetry data, by a RAN Intelligent Controller (RIC) using one or more Artificial Intelligence (AI)/Machine Learning (ML) models, that an issue is occurring with equipment of the RAN, and
directly or indirectly send control instructions to at least one base station of the plurality of base stations via to implement a solution to the issue, by the RIC.

2. The one or more computing systems of claim 1, wherein the RIC is a Non-Real Time (NRT) RIC in the RAN and the computer program instructions are further configured to cause the at least one processor to:
store the telemetry data and equipment information for hardware in the RAN in a data repository;
train the one or more AI/ML models using the stored traffic information, the performance logs, the fault logs, and the equipment information from the data repository, by the NRT RIC or another application of a network core; and
deploy the one or more trained AI/ML models for monitoring the RAN, by the NRT RIC.

3. The one or more computing systems of claim 2, wherein the telemetry data and/or equipment information comprises temperatures, fan speeds, processor loads, memory usage, power consumption, health reports, performance reports, software and/or hardware faults that occurred during operation of respective equipment, dropped calls, bit rates, bands, numbers of users, beamforming information, Signal-to-Noise Ratios (SNRs), Signal-to-Interference-plus-Noise Ratios (SINRs), jitter, makes and models of the equipment, types of hardware in the equipment and their capabilities, numbers and types of antennas, or any combination thereof.

4. The one or more computing systems of claim 1, wherein
the RAN has an Open RAN (O-RAN) architecture, and
the equipment on which the issue is occurring comprises one or more Radio Units (RUs), one or more Distributed Units (DUs), one or more Centralized Units (CUs), or any combination thereof.

5. The one or more computing systems of claim 1, wherein
the computer program instructions comprise an rApp,
the rApp is configured to send the solution to a Near-Real Time (RT) RIC via an A1 interface, and
the xApp of the RT RIC is configured to directly send the control instructions to the at least one base station of the plurality of base stations to implement the solution to the issue.

6. The one or more computing systems of claim 1, wherein the issue comprises parameter mismatches and the control instructions comprise changes to the parameters of one or more Radio Units (RUs), one or more Distributed Units (DUs), one or more Centralized Units (CUs), or any combination thereof.

7. The one or more computing systems of claim 1, wherein the control instructions comprise instructions to reset a Radio Unit (RU), move users to one or more other RUs, change frequency bands used by the RU, change beamforming characteristics for the RU, any combination thereof.

8. The one or more computing systems of claim 1, wherein the one or more AI/ML models are trained to monitor fan speeds of the equipment, temperatures of the equipment, available Random Access Memory (RAM) for the equipment, call drops by the equipment, packet loss rates for the equipment, latency for the equipment, or any combination thereof, over a time period.

9. The one or more computing systems of claim 1, wherein the control instructions comprise instructions to instantiate a new instance of software for a Distributed Unit (DU) or a Centralized Unit (CU) on the DU or the CU.

10. The one or more computing systems of claim 1, wherein the control instructions comprise instructions to migrate a Distributed Unit (DU) or a Centralized Unit (CU) to a different server.

11. The one or more computing systems of claim 1, wherein the one or more AI/ML models are configured to estimate when failure of the equipment will occur due to the issue and the computer program instructions are further configured to cause the at least one processor to:
send a notification to a network engineer or a technician indicating what the issue is and when the issue is predicted to cause a failure.

12. One or more non-transitory computer-readable media storing one or more computer programs for repairing a Radio Access Network (RAN), the one or more computer programs configured to cause at least one processor to:
receive telemetry data comprising traffic information, performance logs, and fault logs from a plurality of base stations of the RAN,
determine based on the telemetry data, by a RAN Intelligent Controller (RIC) using one or more Artificial Intelligence (AI)/Machine Learning (ML) models, that an issue is occurring with equipment of the RAN, and
directly or indirectly send control instructions to at least one base station of the plurality of base stations to implement a solution to the issue, by the RIC, wherein
the RAN has an Open RAN (O-RAN) architecture, and
the equipment on which the issue is occurring comprises one or more Radio Units (RUs), one or more Distributed Units (DUs), one or more Centralized Units (CUs), or any combination thereof.

13. The one or more non-transitory computer-readable media of claim 12, wherein the RIC is a Non-Real Time (NRT) RIC in the RAN and the one or more computer programs are further configured to cause the at least one processor to:
store the telemetry data and equipment information for hardware in the RAN in a data repository;
train the one or more AI/ML models using the stored traffic information, the performance logs, the fault logs, and the equipment information from the data repository, by the NRT RIC or another application of a network core; and
deploy the one or more trained AI/ML models for monitoring the RAN, by the NRT RIC, wherein
the telemetry data and/or equipment information comprises temperatures, fan speeds, processor loads, memory usage, power consumption, health reports, performance reports, software and/or hardware faults that occurred during operation of respective equipment, dropped calls, bit rates, bands, numbers of users, beamforming information, Signal-to-Noise Ratios (SNRs), Signal-to-Interference-plus-Noise Ratios (SINRs), jitter, makes and models of the equipment, types of hardware in the equipment and their capabilities, numbers and types of antennas, or any combination thereof.

14. The one or more non-transitory computer-readable media of claim 12, wherein
the one or more computer programs comprise an rApp,
the rApp is configured to send the solution to a Near-Real Time (RT) RIC via an A1 interface, and
the xApp of the RT RIC is configured to directly send the control instructions to the at least one base station of the plurality of base stations to implement the solution to the issue.

15. The one or more non-transitory computer-readable media of claim 12, wherein the issue comprises parameter mismatches and the control instructions comprise changes to the parameters of the one or more RUs, the one or more DUs, the one or more CUs, or any combination thereof.

16. The one or more non-transitory computer-readable media of claim 12, wherein the control instructions comprise instructions to reset an RU of the one or more RUs, move users to another RU, change frequency bands used by an RU of the one or more RUs, change beamforming characteristics for an RU of the one or more RUs, any combination thereof.

17. The one or more non-transitory computer-readable media of claim 12, wherein the one or more AI/ML models are trained to monitor fan speeds of the equipment, temperatures of the equipment, available Random Access Memory (RAM) for the equipment, call drops by the equipment, packet loss rates for the equipment, latency for the equipment, or any combination thereof, over a time period.

18. The one or more non-transitory computer-readable media of claim 12, wherein the control instructions comprise:
instructions to instantiate a new instance of software for a DU or a CU on the DU or the CU, or
instructions to migrate the DU or the CU to a different server.

19. The one or more non-transitory computer-readable media of claim 12, wherein the one or more AI/ML models are configured to estimate when failure of the equipment will occur due to the issue and the one or more computer programs are further configured to cause the at least one processor to:
send a notification to a network engineer or a technician indicating what the issue is and when the issue is predicted to cause a failure.

20. A computer-implemented method for repairing a Radio Access Network (RAN), comprising:
receiving telemetry data comprising traffic information, performance logs, and fault logs from a plurality of base stations of the RAN, by an rApp of a Non-Real Time (NRT) RAN Intelligent Controller (RIC) executing on one or more computing systems;
determining using one or more Artificial Intelligence (AI)/Machine Learning (ML) models, by the rApp of the NRT RIC, that an issue is occurring with equipment of the RAN;
directly or indirectly sending control instructions to at least one base station of the plurality of base stations to implement a solution to the issue, by the RIC; and
sending a notification to a network engineer or a technician, by the rApp of the NRT RIC, indicating what the issue is and when the issue is predicted to cause a failure based on output from an AI/ML model of the one or more AI/ML models.
